(19) United States
(12) Patent Application Publication
(10) Pub. No.: US 2016/0154486 A1
(43) Pub. Date: Jun. 2, 2016

(54) POSITION INDICATOR

(71) Applicant: Wacom Co., Ltd., Saitama (JP)

(72) Inventors: Mamoru Ogata, Saitama (JP); Takashi Suzuki, Tokyo (JP); Yukio Miyazawa, Saitama (JP)

(21) Appl. No.: 15/013,976

(22) Filed: Feb. 2, 2016

Related U.S. Application Data
(63) Continuation of application No. PCT/JP2014/069805, filed on Jul. 28, 2014.

(30) Foreign Application Priority Data
Aug. 3, 2013 (JP) 2013-161915

(51) Int. Cl. G06F 3/0354; G06F 3/044; G06F 3/038; G06F 3/041

(52) U.S. Cl. CPC G06F 3/03545; G06F 3/0414; G06F 3/044; G06F 3/0383

(57) ABSTRACT

A position indicator includes: a core body including a tip part that protrudes from one opening of a casing in an axial center direction and a rear end part located on a side of the core body opposite to the tip part; a pressure detector that is housed in the casing in a state in which the pressure detector is pressable by the rear end part, and, in operation, detects a writing pressure applied to the tip part based on a pressure received from the rear end part; a retaining member that retains the pressure detector at a predetermined position in the axial center direction in the casing; and an elastic member that is provided between the pressure detector and the core body and that applies a pressure in a direction from the rear end part toward the tip part to the core body.

### BACKGROUND OF THE INVENTION

1. Field of the Invention

The present invention relates to a position indicator capable of detecting a writing pressure, and particularly to a position indicator used with a position detecting device of a capacitive system.

2. Description of the Related Art

In recent years, development of position detecting devices of a capacitive system as a system of position detection of an indicating body used for a touch panel or the like is being actively carried out. The position detecting devices of the capacitive system are used as information input units of pieces of electronic apparatus referred to as so-called tablet information terminals or the like, high-function mobile phone terminals referred to as smartphones or the like, and so forth. The capacitive system includes two types of systems: a surface capacitive type and a projected capacitive type. In both types of systems, predetermined signal processing is executed on the basis of a change in a current value or a change in a voltage caused due to a change in the capacitive coupling state (capacitance or the like) between a sensor electrode and an indicating body (indicating body for inputting a coordinate position, such as a finger or a capacitive pen, the same applies hereinafter), and the result of the signal processing is output as the position of the indicating body.

In recent years, a position indicator that is called a capacitive pen and enables an indication input to the position detecting device of the capacitive system by a method other than the finger is known. As a position indicator called the capacitive pen, there is a position indicator described in Japanese Patent No. 4840891 (hereinafter, Patent Document 1).

It is desired that the pen-type position indicator can output the writing pressure in order to give a pen-like feeling of use. Regarding a position detecting device including a sensor of not the capacitive system but the electromagnetic induction exchange system (electromagnetic resonance (EMR) (registered trademark)) or the like, a position indicator that includes a writing pressure detecting unit and can supply a signal according to the writing pressure exists as an existing position indicator. For this writing pressure detecting unit, e.g., a technique described in Japanese Patent Laid-Open No. 2010-129920 (hereinafter, Patent Document 2) and so forth is used.

FIG. 16 shows a sectional view of a writing pressure detecting unit that is disclosed in Patent Document 2 and uses a variable-capacitance capacitor. The writing pressure detecting unit includes a dielectric 922, a terminal member 923 that biases the dielectric 922, an electrically-conductive member 926, and an elastic member 927. The dielectric 922 has, e.g., a substantially circular disc shape and has a first surface part 922a and a second surface part 922b opposed in substantially parallel to the first surface part 922a. To the first surface part 922a, a first electrode part 936 forming one electrode of the variable-capacitance capacitor is stuck. As shown in FIG. 16, the electrically-conductive member 926 has a curved surface part 926a at its one end in the axial center direction. The curved surface part 926a formed at one end side of the electrically-conductive member 926 in the axial center direction is opposed to the second surface part 922b of the dielectric 922 and forms a second electrode part as the other electrode of the variable-capacitance capacitor.

As shown in FIG. 16, when a force (writing pressure) in a direction toward the variable-capacitance capacitor (dielectric 922) is transmitted to an indicating part (tip) of a core body 912, a retaining member 924 of this variable-capacitance capacitor is pressed by the core body 912. This moves the retaining member 924 toward one end of a housing 921 in the axial center direction. Then, the curved surface part 926a of the electrically-conductive member 926 makes contact with the second surface part 922b of the dielectric 922. When the force is further applied to the indicating part of the core body 912, the electrically-conductive member 926 is pressed by the second surface part 922b of the dielectric 922 and is deformed (flattened). As a result, the contact area between the electrically-conductive member 926 and the second surface part 922b changes and thereby the capacitance value of the dielectric 922 changes.

The change in the capacitance value, which changes according to the writing pressure, can be detected by various methods. For example, a time constant circuit that outputs a signal according to a time constant that changes according to the capacitance value between the terminal member 923 and the elastic member 927 is formed and the configuration is so made as to output the value of this signal to a position detecting device as writing pressure data. This allows the position detecting device side to detect the force (writing pressure) applied to the indicating part (tip) of the core body 912 by processing the writing pressure data.

### SUMMARY OF THE INVENTION

Here, by taking the writing pressure detecting unit described in Patent Document 1 as an example, a consideration will be made about combining a writing pressure detecting unit already existing as a general-purpose product with a capacitive pen and using the writing pressure detecting unit.

In the position detecting device of the capacitive system, normally the indicating body is a finger. Based on the assumption that the indicating body is a finger, the pattern of electrodes in the position detecting device, the method for driving a signal supplied to the electrodes, the timing of detection by receiving electrodes, and so forth are designed to conform to the human finger (width of the finger).

However, regarding the capacitive pen obtained by forming a position indicator into a pen shape, there is a demand to make the pen tip as thin as possible. In order to make the pen tip thin, the pen tip of the capacitive pen is often formed of a deformable elastic body such as electrically-conductive rubber in terms of the component accuracy, the durability, and so forth. The area of the pen tip of the capacitive pen is large relative to the input operation surface of the position detecting device compared with the pen tip of general writing materials such as ballpoint pens. However, compared with a finger of a user, physical quantities (represented by the area, hereinafter) that contribute to detection of change in the capacitance caused when the pen tip comes close to the position detecting device are small.

Therefore, in the case of using a capacitive pen using a pen tip formed of electrically-conductive rubber or the like, it is usual to use the capacitive pen with application of a certain level of force to the input operation surface of a position detecting device. The pen tip is deformed and a force to press the pen tip to the area for stable acting for change in the capacitance is applied to the input operation surface of the position detecting device. This allows the capacitive pen to be stably used even with the position detecting device having a sensor designed optimally for use with a finger.

Hereinafter, in the present specification, the force (or partial force) necessary for the deformation of a pen tip from (1) the contact of the tip end of the pen tip with the operation surface of a position detecting device until (2) the contact position is grasped by the position detecting device as the pen tip position in the case of using a position indicator to the certain one position detecting device will be defined as the “initial load.” This force is a force distinguished from a force by a spring or the like for keeping the protrusion state of the pen tip or the OFF-state of a built-in switch and is preferably a force equal to or larger than 5 gf.

FIG. 17 is a diagram showing the relationship (input-output characteristic) between input (force to press a pen tip against a position detecting device) and output (pressure level detected by the position detecting device) in an assumed writing pressure detecting system including a capacitive pen using the writing pressure detecting unit shown in FIG. 16. With reference to FIG. 17, the initial load will be described below.

In FIG. 17, the abscissa indicates the input of the writing pressure detecting system, i.e., the load (unit is gf) applied from the input operation surface of the position detecting device to the pen tip. The ordinate indicates the output of the writing pressure detecting system output by the position detecting device, i.e., an example of the pressure level decided corresponding to the load. As shown in the correspondence in FIG. 17, the position detecting device that operates as the output side outputs the corresponding pressure level as a digital value of a predetermined number of bits, such as 0 to 2047, according to the load applied to the pen tip.

In the example of FIG. 17, an effective input range R that is effective as the range of the input has a width of 500 gf from 0 gf to 500 gf. A segment A in FIG. 17 indicates an input width corresponding to the above-described initial load in this effective input range. If the writing pressure detecting unit described in Patent Document 1 is applied to the capacitive pen as it is, in the segment A, the position detecting device of the capacitive system cannot detect which coordinate position is indicated even though writing pressure data can be transmitted from the capacitive pen.

With a focus on the existence of a difference between this initial load, i.e., the load beyond which detection of the position indicated by a capacitive pen is enabled, and the load that can be output by the capacitive pen as writing pressure data, this disclosure intends to realize a position indicator that uses a pressure sensor or the like that outputs writing pressure data corresponding to a predetermined force applied to the pen tip as a writing pressure detecting unit and allows the writing pressure data to be accurately utilized in a position detecting device of the capacitive system or the like.

In particular, with a focus on the initial load, this disclosure realizes a position indicator that keeps the flexibility in selection of a pen tip member while using the writing pressure detecting unit without the need for a special improvement in the writing pressure detecting unit, with the accuracy of existing products kept.

A position indicator according to a first aspect of the present disclosure for solving the above-described problem includes a core body including a tip part that protrudes from one opening of a casing in an axial center direction to an external and a rear end part located on an opposite side to the tip part, and a pressure detecting unit that is housed in the casing in a state in which the pressure detecting unit is allowed to be pressed by the rear end part, and detects a writing pressure applied to the tip part on a basis of a pressure received from the rear end part. The position indicator further includes a retaining member that retains the pressure detecting unit at a predetermined position in the axial center direction in the casing, and an elastic member that is provided between the pressure detecting unit and the core body and is for applying a pressure in a direction from the rear end part toward the tip part to the core body.

In the position indicator according to the first aspect, the following configuration may be employed. The tip part is configured to be deformed according to the writing pressure, and the position indicator is used by pressing the tip part against an operation surface of a position detecting device. Furthermore, the position detecting device is configured to start detection of a contact position of the tip part in the operation surface if an amount of deformation of the tip part reaches a predetermined amount after the tip part makes contact with the operation surface, and the pressure is a pressure equal to or lower than an initial load that is the writing pressure at which the amount of deformation of the tip part becomes the predetermined amount.

Furthermore, the position detecting device may be a position detecting device of a capacitive system, and the tip part may have electrical conductivity.

Moreover, the core body may include a flange part having a shape that bulges from a main body part of the core body located between the tip part and the rear end part, and the flange part may include two surfaces whose normal directions are each the axial center direction.

In addition, a gap may be formed between the rear end part and the pressure detecting unit in a state in which the writing pressure is not applied to the tip part.

A position indicator according to a second aspect of the present disclosure has the following configuration. Specifically, in the position indicator according to the first aspect, the elastic member is so configured that resilience in a state in which the writing pressure is not applied to the tip part is lower than a force of an upper-limit value of the initial load.

A position indicator according to a third aspect of the present disclosure is a position indicator used with a receiving device including a control unit capable of processing writing pressure data. The position indicator includes a core body including a pen tip part, a pressure detecting unit that detects a force transmitted from the core body, and a writing pressure transmitting unit that is triggered to transmit information relating to an initial load by establishment of communication with the receiving device, and then continuously transmits the writing pressure data indicating the force detected by the pressure detecting unit.

According to the first aspect of the present invention, the elastic member between the core body and the pressure detecting unit biases the core body in order to adjust a force corresponding to part of the initial load due to the resilience given at the time of assembling due to the engagement between the core body and the casing or the core body locking member.

This adjustment allows the pen tip member to be selected depending on the position detecting device independently of the pressure detecting unit. Therefore, the flexibility in the design of the position indicator can be improved.

According to the second aspect of the present disclosure, in the state in which the position indicated by the position indicator can be detected by the position detecting device, the writing pressure data in addition to the position can be surely supplied from the position indicator to the position detecting device.

According to the third aspect of the present disclosure, it is possible to realize a position indicator that can offer, to the position detecting device, processing of properly correcting the difference in the reaction load between the pressure detecting unit and the position detecting device.

### BRIEF DESCRIPTION OF THE DRAWINGS

FIG. 1 is a configuration diagram of a system including a position indicator;

FIG. 2 is a functional block diagram of the position indicator;

FIG. 3 is a functional block diagram of a tablet information terminal;

FIG. 4 is a sectional view of the position indicator;

FIG. 5 is a diagram for explaining constituent members of a writing pressure detecting mechanism unit of the position indicator;

FIG. 6 is a sectional view showing a mechanism for attaching to a casing in the writing pressure detecting mechanism unit;

FIG. 7 is a diagram showing a state in which the writing pressure detecting mechanism unit is not in contact with an input operation surface;

FIGS. 8A and 8B show enlarged views of a part surrounded by a circle in FIG. 7 (part including a core body and a core body locking member);

FIG. 9 is a diagram showing a state in which a pressing force applied to the core body on which a cap is mounted has reached a force that is the upper limit of an initial load or larger;

FIGS. 10A and 10B show enlarged views of a part surrounded by a circle in FIG. 9 (part including the core body and the core body locking member);

FIG. 11 is a diagram for explaining the operation of a position indicator of the present disclosure on the basis of the input-output characteristic of a system of a related-art position indicator including a pressure detecting unit described with FIG. 16;

FIG. 12 is a diagram for explaining adjustment of the initial load;

FIG. 13 is a flow diagram showing the operation of the position indicator;

FIGS. 14A and 14B show diagrams for explaining one example of an application using adjustment of a writing pressure value in the tablet information terminal;

FIGS. 15A and 15B show diagrams for explaining one example of a pressure detecting unit using a micro electro mechanical system (MEMS);

FIG. 16 is a sectional view of a writing pressure detecting unit of a related art using a variable-capacitance capacitor; and

FIG. 17 is a diagram showing the input-output characteristic of an assumed writing pressure detecting system including a capacitive pen using the writing pressure detecting unit shown in FIG. 16.

### DETAILED DESCRIPTION OF THE PREFERRED EMBODIMENTS

Embodiments of the position indicator according to the present disclosure will be described below with reference to the drawings.

### First Embodiment

### System Including Position Indicator 100

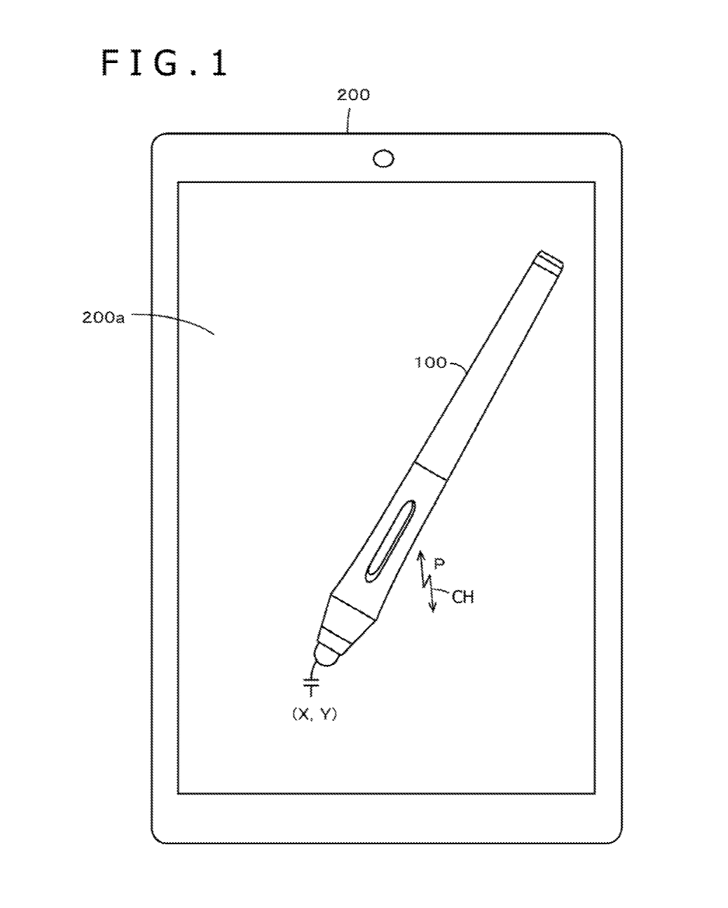

FIG. 1 is a configuration diagram of a system including a position indicator 100. The position indicator 100 has a pen-shaped appearance and is configured to allow a user to hold the position indicator 100 with a hand like a pen and carry out operation such as position indication to an input operation surface 200a.

The position indicator 100 is configured to allow a change in the capacitive coupling state to be caused near a contact position (in FIG. 1, (X, Y)) between the pen tip (tip of a core body, the same applies hereinafter) to be described later and the input operation surface 200a. A position detecting unit (to be described later) of a tablet information terminal 200 is configured to detect the contact position of the pen tip by detecting change in the capacitance value caused due to the change in the capacitive coupling state.

The tablet information terminal 200 includes the position detecting unit that is a sensor of a capacitive system that detects change in the above-described capacitive coupling state. Furthermore, the tablet information terminal 200 has the input operation surface 200a to which an operation with the position indicator 100 is carried out. The input operation surface 200a is formed of glass or the like.

A communication channel CH shown in FIG. 1 is a communication path between the position indicator 100 and the tablet information terminal 200. The position indicator 100 transmits or supplies various kinds of information such as writing pressure data (P in FIG. 1) to the tablet information terminal 200 via the communication channel CH. The tablet information terminal 200 receives the transmitted information and executes processing for displaying and so forth according to the contents of the information.

[Position Indicator 100]

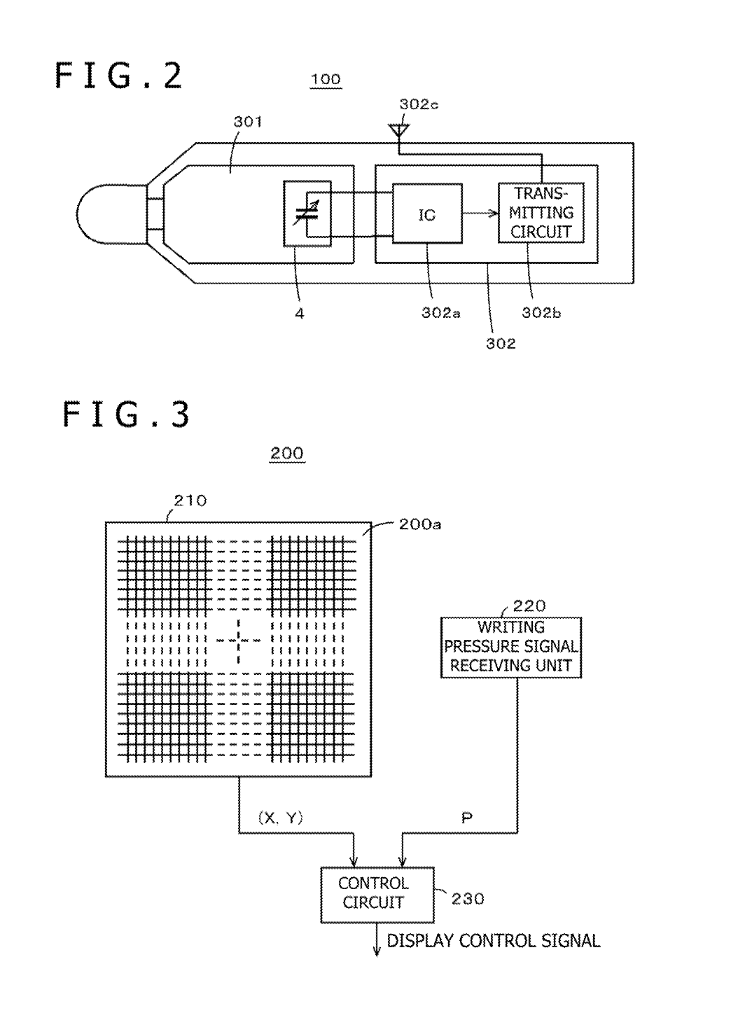

FIG. 2 is a functional block diagram of the position indicator 100. The position indicator 100 includes a writing pressure detecting mechanism unit 301 and a writing pressure signal transmitting unit 302.

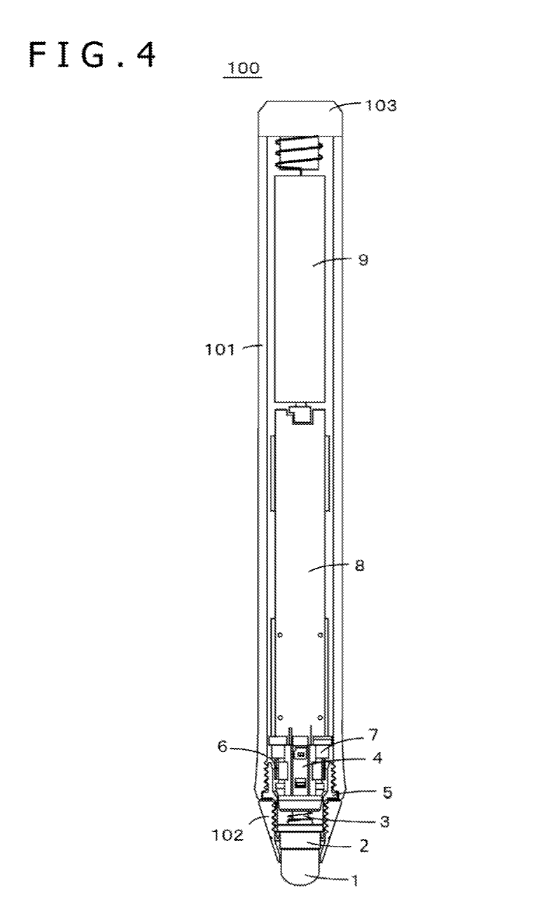

The writing pressure detecting mechanism unit 301 converts an amount of force applied to the tip of the core body (or reaction force obtained in the direction vertical to the input operation surface 200a, hereinafter referred to as the writing pressure) to an amount that can be extracted as an electrical signal (e.g., capacitance C, voltage level V, etc.). The writing pressure detecting mechanism unit 301 is one of the major parts of the disclosure according to the present embodiment and details thereof will be described in FIG. 4 and the subsequent drawings.

The writing pressure signal transmitting unit 302 includes an integrated circuit (IC) 302a and a transmitting circuit 302b. The IC 302a is an IC that converts the writing pressure to a predetermined signal. The IC 302a includes, e.g., a time constant circuit and a clock counter (neither is shown). The time constant circuit outputs, to the clock counter, a timing control signal corresponding to a time according to a time constant decided depending on the capacitance C of a pressure detecting unit 4 provided in the writing pressure detecting mechanism unit 301. The clock counter counts a clock supplied from an oscillator that drives the IC over a time specified by the timing control signal from the time constant circuit, and outputs a count value to the transmitting circuit 302b at the subsequent stage.

The transmitting circuit 302b supplies the count value to the tablet information terminal 200 by a predetermined communication system. In the present embodiment, the count value is writing pressure data of a digital format represented by a bit sequence. The transmitting circuit 302b sums up the count value supplied from the IC 302a with a predetermined window time (smoothing processing) and thereafter shapes the count value into the format as the writing pressure data. Then, the transmitting circuit 302b sends out the writing pressure data through an antenna 302c set at any position on the casing of the position indicator 100 by using a PHY/MAC communication standard such as Bluetooth (registered trademark).

[Tablet Information Terminal 200]

FIG. 3 is a diagram showing a configuration example of the tablet information terminal 200 used with the position indicator 100. The tablet information terminal 200 includes a sensor unit 210 forming a touch panel (detecting sensor), a writing pressure signal receiving unit 220, and a control circuit 230.

The sensor unit 210 includes plural electrodes. An insulating layer is disposed at the positions adjacent to the respective electrodes in the normal direction of the input operation surface. The sensor unit 210 detects change in the capacitive coupling state caused near the contact position between the position indicator 100 and the input operation surface 200a as change in a current or voltage, and extracts position information from the detection result to supply it to the control circuit 230. That is, the sensor unit 210 forms the position detecting unit that detects the position indicated by the position indicator 100.

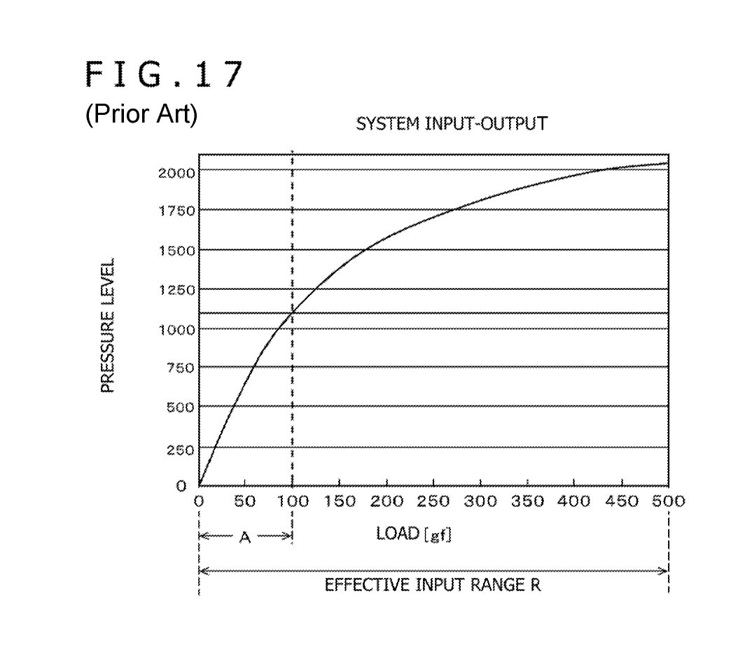

The writing pressure signal receiving unit 220 receives a bit sequence (writing pressure data) according to the writing pressure from the position indicator 100 via an antenna. The writing pressure signal receiving unit 220 detects a writing pressure value from the received bit sequence by using the desired correspondence curve (writing pressure curve) exemplified in FIG. 17 and uses the result thereof for displaying and so forth. The writing pressure signal receiving unit 220 can be formed with a communication part that implements communications based on Bluetooth (registered trademark) or the like and software that operates on a control circuit for interpreting the bit sequence in accordance with a protocol decided between the tablet information terminal 200 and the position indicator, and special hardware does not need to be prepared on the tablet side. By giving interpretation of the bit sequence received on the tablet by software that can be updated, it becomes possible to form the pen tip and so forth of the position indicator 100 by arbitrary materials.

Due to the above configuration, in the tablet information terminal 200, according to the position indicated by the position indicator 100, data processing according to the supplied writing pressure data (e.g., display processing of reflecting the writing pressure in the width of a line) at the corresponding position on the display screen (input operation surface 200a) of the tablet information terminal 200.

Constituent Parts of Position Indicator 100

FIG. 4 is a sectional view of the pen-type position indicator 100. The position indicator 100 includes a casing 101, a core body 2, an elastic member 3, and the pressure detecting unit 4 as a configuration. Moreover, a cap 1, a core body locking member 5, a retaining member 6, a holder 7, and/or a circuit board 8 can be configured in combination.

On the tip side of the position indicator 100, the core body 2, the elastic member 3, and the pressure detecting unit 4 are disposed to be housed inside the core body locking member 5 formed into a tubular shape. The core body locking member 5 has, in its outer circumference, a part having a thread screwed to a thread made inside a ferrule 102 and a part having a thread screwed to a thread provided inside the casing 101 on the opposite side to a lid portion 103.

The core body 2 is a component formed of an electrically-conductive material such as a metal or an electrically-conductive resin. The core body 2 is so provided that its one end (tip part) on the pen tip side protrudes from the end part of the ferrule 102 on the opposite side to the casing 101. To the part protruding from the ferrule 102 in the core body 2, the cap 1 formed of a material having electrical conductivity and elasticity, such as electrically-conductive rubber, is attached. The cap 1 functions also as a component that protects the input operation surface 200a of the tablet information terminal 200 and can be attached and detached to and from the core body 2.

The pressure detecting unit 4 can be pressed by the end part of the core body 2 on the opposite side to the side on which the cap 1 is attached (rear end part). The pressure detecting unit 4 detects the writing pressure applied to the core body 2 due to a load directly (or indirectly via a component) propagated from the core body 2. The pressure detecting unit 4 is fixed to the retaining member 6 by the holder 7.

As shown in FIG. 4, the elastic member 3 is provided between the core body 2 and the pressure detecting unit 4. The retaining member 6 of the substrate and so forth is formed of a material having electrical conductivity and has a structure extended in the longitudinal direction of the circuit board 8. To the retaining member 6, the circuit board 8 is fixed and the electrically-conductive elastic member 3 formed of a coil spring is also connected. The casing 101 formed of an electrically-conductive material is also connected to the retaining member 6.

The body of a user who makes contact with the casing is electrically connected to the tablet information terminal 200 of the capacitive system via the casing 101, the retaining member 6, the elastic member 3, the core body 2, and the cap 1. This enables a change in the capacitive coupling state (capacitance) in the tablet information terminal 200 of the capacitive system.

The holder 7 is a component formed of, e.g., resin and plays a role in fixing the pressure detecting unit 4 to the retaining member 6. Due to this, the position of the pressure detecting unit 4 in the casing 101 of the position indicator 100 is fixed. On the circuit board 8, the writing pressure signal transmitting unit 302 (FIG. 2) including the IC 302a that receives a supply of a detection output from the pressure detecting unit 4 and forms a pressing signal (above-described count value) as a digital signal and the transmitting circuit 302b that transmits this pressing signal to the tablet information terminal 200, and so forth are provided. Furthermore, as shown in FIG. 4, a battery 9 is attachably/detachably connected to the end part of the circuit board 8 on the side remoter from the pen tip. The battery 9 provides a supply voltage to the circuit part of the circuit board 8.

Writing Pressure Detecting Mechanism Unit 301

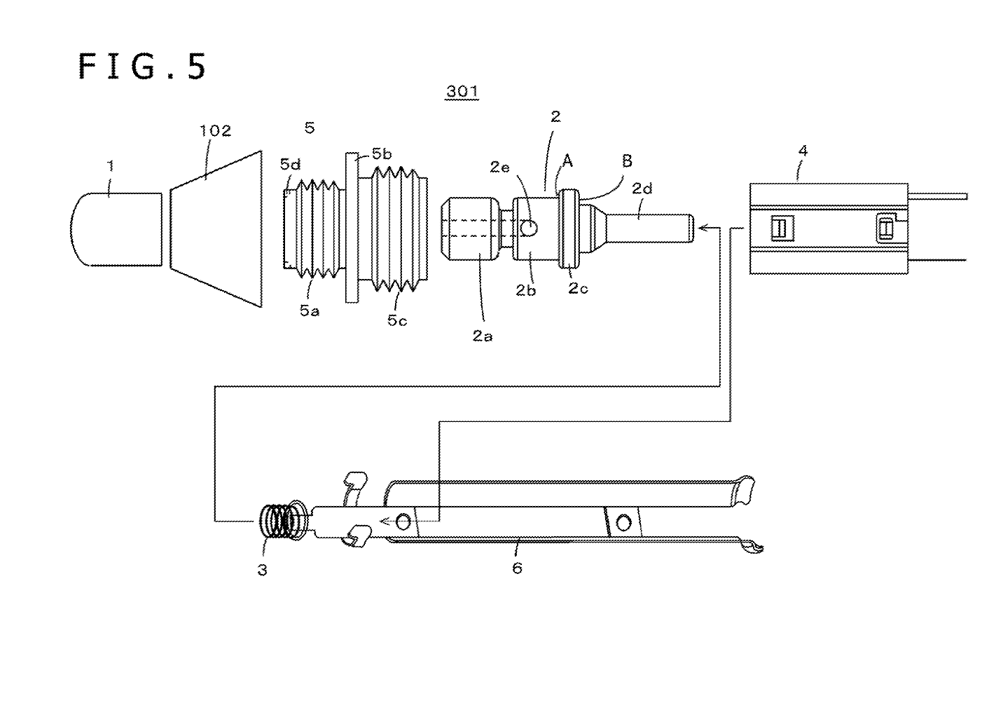

FIG. 5 is a diagram for explaining constituent members of the writing pressure detecting mechanism unit 301 of the position indicator 100 of the present embodiment. The cap 1 is a component that is deformed according to the writing pressure and is for enabling position detection on the side of the tablet information terminal 200. As the material of the cap 1, a material having electrical conductivity and elasticity providing resilience against deformation, such as electrically-conductive rubber, is used. The cap 1 is so deformed that the contact surface becomes about 5 mm in diameter, for example.

The core body 2 includes a cap retaining part 2a, an air-hole-disposed part 2b, a flange part 2c, a pressing part 2d, and an air hole 2e. The cap retaining part 2a is a part to which the cap 1 is attached. The cap 1 is mounted to be put over the cap retaining part 2a. By employing such a configuration, in the position indicator 100, the material and shape of the cap 1 can be selected depending on the sensor unit 210 (FIG. 3) of the tablet information terminal 200 to be used and independently of the pressure detecting unit 4.

In the core body 2, the air hole 2e for letting out air inside the cap 1 when the cap 1 is pressed against the input operation surface 200a of the tablet information terminal 200 and is deformed to collapse is made. In the range from the cap retaining part 2a to the air-hole-disposed part 2b, the air hole 2e is made along the direction along the central axis of the core body 2 (central line of the core body 2 parallel to the longitudinal direction of the core body 2) as shown by a dotted line in FIG. 5. In the air-hole-disposed part 2b, the air hole 2e is made along the direction orthogonally intersecting the central axis of the core body 2.

Furthermore, the flange part 2c of the core body 2 is a part that bulges from the other part (main body part) of the core body 2 in the direction orthogonal to the central axis of the core body 2 by one stage or plural stages. The flange part 2c includes two surfaces (surfaces A and B) whose normals are along the axial center direction due to the bulging and thereby have two functions described below.

1) First, the flange part 2c (surface A) serves as a part that engages with a protrusion 5d provided on the inner circumference of an end part of the core body locking member 5. By the engagement between the protrusion 5d provided on the inner circumference of the end part of the core body locking member 5 and the flange part 2c of the core body 2, the part in the core body 2 closer to the pressing part 2d than the flange part 2c is prevented from protruding from the end part of the core body locking member 5. That is, the position of the core body 2 is restricted so that the core body 2 may be prevented from protruding to the outside of the position indicator 100 more than necessary. The core body 2 is allowed to slide-move in the direction toward the side on which the pressure detecting unit 4 is provided. The pressing part 2d of the core body 2 presses the pressure detecting unit 4 directly or indirectly.

2) Moreover, the flange part 2c (surface B) has a diameter larger than the diameter of the main body part of the core body 2 and provides a surface for receiving resilience from the elastic member (coil spring) 3 disposed to surround the main body part of the core body 2. The surface B further has a role in allowing the flange part 2c (surface B) of the core body 2 to provide, in a wide area range, a point serving as (a) a contact point for conducting a charge between the flange part 2c and the elastic member (coil spring) 3 (contact point for generating the movement of a charge between the body of a user and the cap 1 in order to cause change in the above-described capacitive coupling state near the input operation surface 200a) and (b) a point of application of resilience from the elastic member 3.

The elastic member (coil spring) 3 is so provided that the pressing part 2d of the core body 2 penetrates the elastic member 3, and is connected to the retaining member 6 as shown in FIG. 5. At a predetermined position on the retaining member 6 close to the elastic member 3, the pressure detecting unit 4 is fixed by the holder 7. Furthermore, the retaining member 6 is mounted on the circuit board 8 shown in FIG. 4 and thereby is fixed so as not to move in the casing 101 of the position indicator 100.

As shown in FIG. 5, the core body locking member 5 includes a ferrule joining part 5a having the thread screwed to the thread made inside the ferrule 102, a position restricting part 5b, and a casing joining part 5c having the thread screwed to the thread made inside the casing 101. Inside the core body locking member 5, the core body 2, the elastic member 3, and the pressure detecting unit 4 are housed. The core body locking member 5 is attached to the casing 101, with the casing joining part 5c screwed to the thread inside the casing 101.

The elastic member 3 is disposed to be interposed between the core body 2 and the pressure detecting unit 4. The pressure detecting unit 4 is configured to be allowed to be pressed by the pressing part 2d of the core body 2. Furthermore, the ferrule 102 is attached to the ferrule joining part 5a of the core body locking member 5 in such a manner as to be screwed to the thread inside the ferrule 102. Moreover, the cap 1 is attached to the cap retaining part 2a of the core body 2. Thus, the position indicator 100 that has an outer shape shown in FIG. 4 and is used as an indicating body for the tablet information terminal 200 is obtained.

[Casing Attaching Mechanism of Writing Pressure Detecting Mechanism Unit 301]

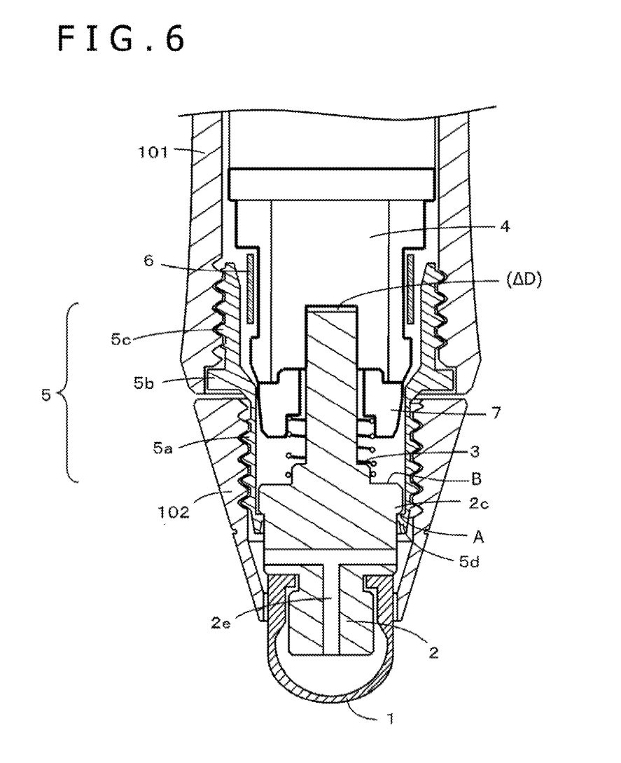

FIG. 6 is a sectional view showing a mechanism for attaching to the casing 101 in the writing pressure detecting mechanism unit 301. In FIG. 6, a state in which the writing pressure detecting mechanism unit 301 is attached to the position indicator 100 (state in which the cap 1 is not in contact with the input operation surface 200a) is shown. The thread made in the inner circumference of the casing 101 on the tip side, which is the side on which the ferrule 102 is provided, is screwed to the thread of the casing joining part 5c of the core body locking member 5 and thereby the core body locking member 5 is attached to the casing 101.

In the core body locking member 5, the position restricting part 5b is provided to extend outward. By the function of the position restricting part 5b, the core body locking member 5 is prevented from being pushed toward the lid portion 103 of the casing 101 more than necessary. The attaching position of the position restricting part 5b is so set as to prevent the core body locking member 5 from being separate from the tip part of the position indicator 100 (from entering the inside of the position indicator 100) more than necessary.

The core body 2, the elastic member 3, and the pressure detecting unit 4 are provided to be housed in the core body locking member 5. The pressure detecting unit 4 is fixed at a predetermined position on the retaining member 6 by the holder 7. Furthermore, the retaining member 6 itself is fixed at a predetermined position in the position indicator 100. Thus, the position of the pressure detecting unit 4 is fixed relative to the casing 101 in the casing 101 of the position indicator 100.

The core body 2 is so disposed that the pressing part 2d presses the pressure detecting unit 4. In this case, as shown in FIG. 6, the flange part 2c (surface A) of the core body 2 engages with the protrusion 5d provided on the inner circumference of the end part of the core body locking member 5 on the tip side and thereby the position of the core body 2 is restricted so that the core body 2 may be prevented from protruding toward the tip part of the position indicator 100 more than necessary.

Furthermore, as shown in FIG. 6, the elastic member 3 is provided between the flange part 2c (surface B) of the core body 2 and the holder 7 that retains the pressure detecting unit 4. The elastic member 3 is an electrically-conductive member and is, e.g., a metallic coil spring. In the attached state shown in FIG. 6, the elastic member 3 is in the state of being compressed to a length shorter than the natural length by the length restricted by the position restricting part 5b.

The cap 1 is mounted on the cap retaining part 2a of the core body 2 and the thread inside the ferrule 102 is screwed to the ferrule joining part 5a of the core body locking member 5, which provides the state in which the ferrule 102 is attached to the casing 101. Due to this, the core body 2 is retained inside the casing of the position indicator 100 in the state in which the core body 2 does not protrude from the core body locking member 5 toward the tip side more than necessary but is movable toward the pressure detecting unit 4.

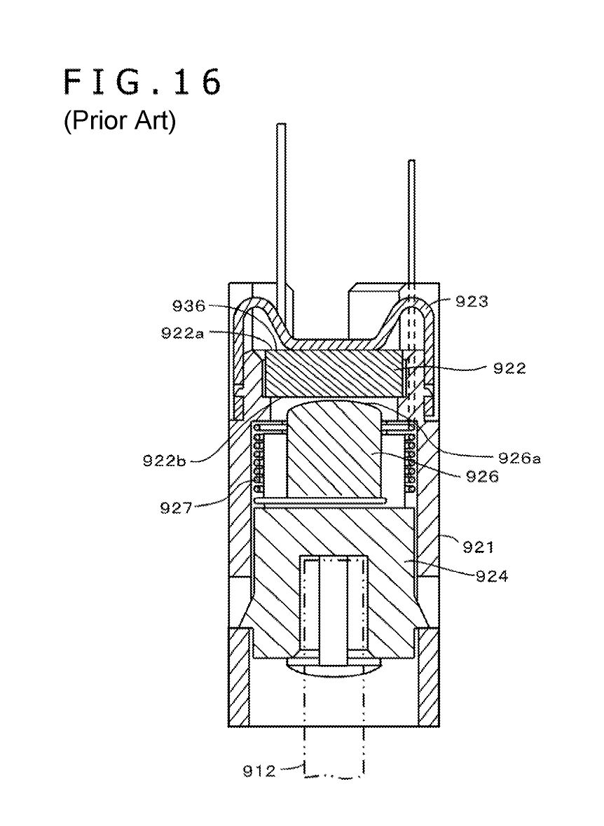

As the pressure detecting unit 4 of the present embodiment, the variable-capacitance capacitor of the related art described by using FIG. 16 can be used. Specifically, the pressure detecting unit 4 has a configuration in which a first electrode and a second electrode are provided to sandwich a dielectric and an electrical conductor forming the second electrode is pressed against the dielectric through a retaining member in the pressure detecting unit 4 according to a writing pressure applied to the core body 2. The pressure detecting unit 4 provides, to the writing pressure signal transmitting unit 302, a capacitance value (capacitance C) between elastic members provided around the electrical conductor as an amount that changes according to the writing pressure by a terminal connected to the first electrode and the second electrode.

Operation of Writing Pressure Detecting Mechanism Unit 301

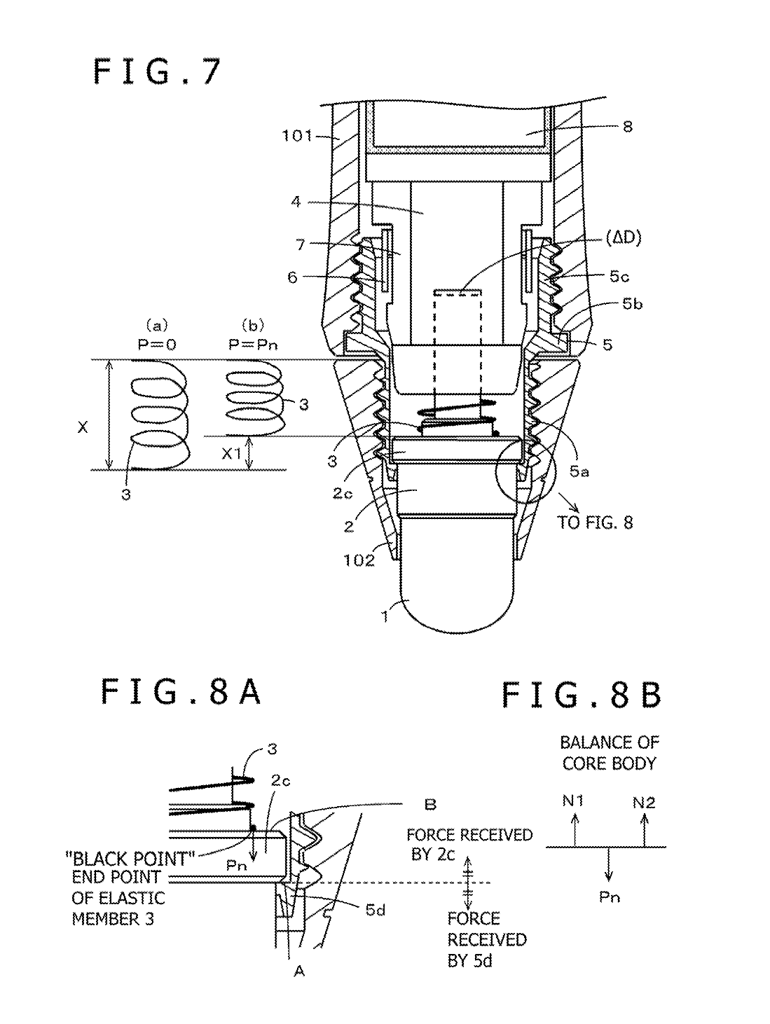

FIG. 7 is a diagram showing a state in which the writing pressure detecting mechanism unit 301 is not in contact with the input operation surface 200a. The pressure detecting unit 4 is fixed to the retaining member 6. The circuit board 8 is also fixed to the retaining member 6 and the retaining member 6 is fixed at a predetermined position in the casing 101. The coil spring as the elastic member 3 is mounted around the pressing part 2d of the core body 2. Furthermore, in the state in which the core body 2 and the elastic member 3 are housed in the core body locking member 5, the thread of the casing joining part 5c of the core body locking member 5 is screwed to the thread inside the tip part of the casing 101 and the core body locking member 5 is fixed to the casing 101.

A natural length of the elastic member 3 (length in the state in which a force is not applied (state in which the elastic member 3 is not biased)) is X (resilience P=0) as shown in (a) of FIG. 7.

In the writing pressure detecting mechanism unit 301 of the present embodiment, due to the engagement between the core body 2 (flange part 2c (surface A)) and the core body locking member 5, the length of the elastic member 3 disposed between the core body 2 and the pressure detecting unit 4 is shortened from the natural length X by X1 (offset length) as shown in (b) of FIG. 7. As described above, the pressure detecting unit 4 is fixed to the retaining member 6 fixed relative to the casing 101 and thus the elastic member 3 can apply a predetermined force Pn corresponding to the above-described compression by X1 (force corresponding to the initial load) between the core body 2 and the pressure detecting unit 4.

That is, the elastic member 3 is in the state of giving a pressure of the pressure value Pn to the core body 2 in the direction toward the tip side of the position indicator 100 (downward direction in FIG. 7).

FIG. 8A is an enlarged view of a part surrounded by a circle in FIG. 7 (part including the core body 2 and the core body locking member 5). The core body 2 is biased by the force Pn in the downward direction in FIG. 8A due to the resilience (elastic force) of the elastic member 3. In the state in which the core body 2 (cap 1) is not in contact with the input operation surface 200a, the surface A of the flange part 2c is locked by the protrusion 5d of the core body locking member 5. This prevents the core body 2 from sticking out from the position indicator 100 having a tubular shape under the situation in which the above-described resilience is applied to the core body 2.

Between the surface A of the flange part 2c and the protrusion 5d of the core body locking member 5, force action and reaction shown by arrows in both upward and downward directions are caused due to biasing of the elastic member 3 (black point in FIG. 8A) toward the surface B of the flange part 2c.

Simply stated, the core body 2 receives a force (Pn) in the downward direction from the external and forces (N1 and N2) in the upward direction from the external and is in balance according to the following relationship (FIG. 8B).

Pn=N1+N2;

In this expression,

Pn: force applied from an end point of the elastic member 3 as a spring to the core body 2 in the downward direction in FIG. 8B (force corresponding to the initial load),

N1: writing pressure (normal force transmitted from the input operation surface 200a through the pen tip to be applied to the core body 2), and

N2: normal force of a residue given from the core body locking member 5 (residue resulting from subtraction of N1 from Pn).

If N1 is 0, Pn=N2 holds. If N1 is Pn, Pn=N1 holds.

The elastic member 3 causes the force Pn of pressing down in the tip direction to act on the flange part 2c (action) and thereby the protrusion 5d of the core body locking member 5 receives a force in a direction shown by a downward arrow. In the state in which the protrusion 5d engages with the flange part 2c of the core body 2, the core body locking member 5 does not move the core body 2 in the downward arrow direction. Thus, the core body locking member 5 causes a force equivalent to the force by the elastic member 3 to act in an upward arrow direction (reaction N2=Pn) and thereby prevents the flange part 2c of the core body 2 from protruding from the tip of the core body locking member 5.

To the position indicator 100, a pressing force in a direction from the cap 1 toward the casing 101 is applied as the reaction against the writing pressure. However, the core body 2 in the state in which the pressure corresponding to the force Pn is applied thereto in the direction toward the tip (cap 1) by the elastic member 3 does not move toward the pressure detecting unit 4 until a pressing force surpassing the force Pn is applied thereto.

While the pressing force applied to the core body 2 on which the cap 1 is mounted in the direction from the cap 1 toward the casing 101 is equal to or smaller than the force Pn (≦Pn (gf)), the core body 2 does not move toward the pressure detecting unit 4. Therefore, the range of this pressing force is an interval in which writing pressure detection is not carried out substantially.

FIG. 9 is a diagram showing a state in which the pressing force N1 applied to the core body 2 on which the cap 1 is mounted reaches the force Pn or larger (N1≧Pn). (a) of FIG. 9 shows a case in which a pressing force equal to the force Pn is applied to the core body 2 on which the cap 1 is mounted in the direction toward the lid portion 103. (b) of FIG. 9 shows a case in which a pressing force Pn+α larger than the force Pn is applied to the core body 2 on which the cap 1 is mounted in the direction toward the lid portion 103.

As shown in (a) of FIG. 9, in the state in which the force Pn applied from the inside of the position indicator 100 to the core body 2 by the elastic member 3 balances with the pressing force from the external (state in which force action and reaction are generated), the core body 2 does not move and no force is transmitted to the pressure detecting unit 4.

On the other hand, when the pressing force applied to the core body 2 on which the cap 1 is mounted in the direction from the cap 1 toward the casing 101 surpasses the force Pn, the core body 2 starts moving toward the pressure detecting unit 4. At this time, first the elastic member 3 is compressed and increases its resilience to counteract this movement. However, in the position indicator 100, a gap AD between the pressing part 2d of the core body 2 and the pressure detecting unit 4 shown in FIG. 7 is set very small as described later. Therefore, in the following, description will be advanced in disregard of this increase in the resilience. When the pressing force further increases and the core body 2 makes contact with the pressure detecting unit 4, the elastic member 3 is not compressed more. After this state is obtained, a force according to the pressing force Pn+a is transmitted from the core body 2 to the pressure detecting unit 4. Specifically, a force of Pn+α−Pn=α is transmitted from the core body 2 to the pressure detecting unit 4 as shown in (b) of FIG. 9.

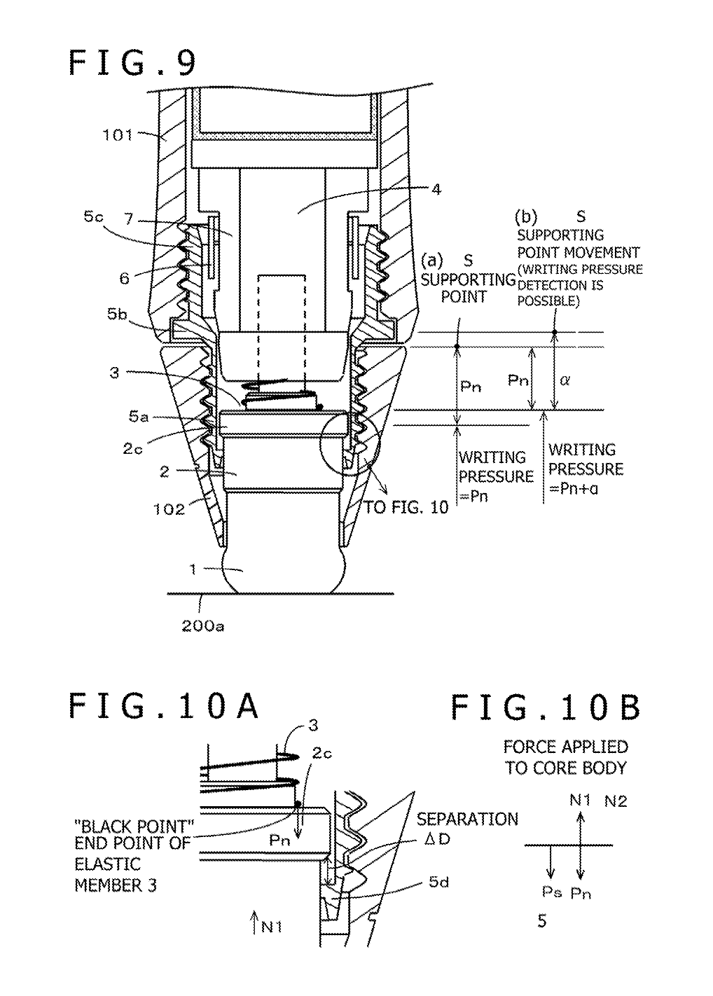

FIG. 10A is an enlarged view of a part surrounded by a circle in FIG. 9 (part including the core body 2 and the core body locking member 5). When the pressing force applied to the core body 2 on which the cap 1 is mounted in the direction from the cap 1 toward the casing 101 surpasses the force Pn, the flange part 2c of the core body 2 that engages with the protrusion 5d of the core body locking member 5 thus far comes not to obtain the reaction from the protrusion 5d (N2 becomes 0) and gets away from the protrusion 5d. The end part of the pressing part 2d of the core body 2 (supporting point) moves to press the pressure detecting unit 4. As a result, detection of the pressing force in the pressure detecting unit 4 becomes possible.

As shown by ΔD in FIG. 7, only a very slight gap is made between the pressing part 2d of the core body 2 and the pressure detecting unit 4. For this reason, even when the pressing force applied to the core body 2 on which the cap 1 is mounted in the direction from the cap 1 toward the casing 101 surpasses the force Pn, only a very slight gap is generated between the protrusion 5d of the core body locking member 5 and the flange part 2c of the core body 2 (see AD in FIG. 10A). Preferably, this gap can be set to have a distance that is at least 1 μm and at most 300 μm.

As shown in FIG. 7, AD is so small as to be substantially ignorable compared with X1. In other words, the elastic member 3 is not expanded and contracted substantially and is compressed by the distance of X1 (offset length) in advance in order to give a bias as a force (bias of force) in advance and consequently generates the force Pn.

In this point, the resilience of the elastic member 3 corresponding to the force Pn is a force distinguished from a force for keeping the protrusion state of the movable pen tip or a force by a spring or the like for keeping the OFF-state of a built-in switch. This resilience is preferably a force that is at least 5 gf and at most 100 gf. Specifically, the resilience can be set to a force that is at least 10 gf and at most 85 gf.

FIG. 10B is a diagram showing the balance of the forces applied to the core body 2. In the diagram, a force Ps is a force the core body 2 receives from the pressure detecting unit 4 (reaction of the force of pressing of the pressure detecting unit 4 by the core body 2).

The core body 2 receives the normal force N1 in the upward direction as a writing pressure and receives each of the force Pn from the elastic member 3 and the force Ps from the pressure detecting unit 4 in the downward direction. Thus, the core body 2 is in balance. Therefore, N1=Pn+Ps holds. If N1=Pn+α holds, Ps=(Pn+α)−Pn=α is satisfied.

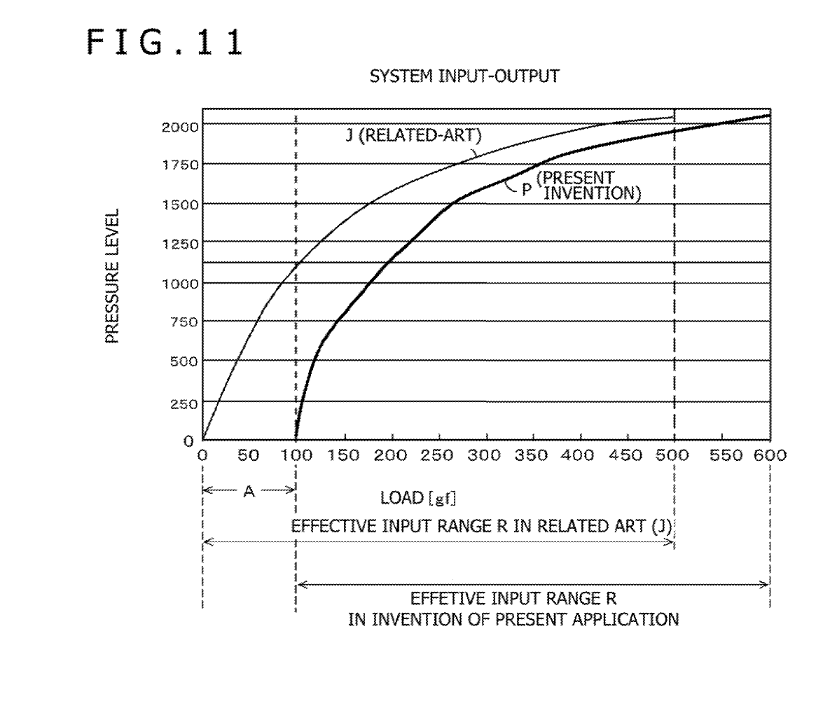

FIG. 11 is a diagram for explaining the operation of the position indicator 100 of the present invention on the basis of the input-output characteristic of the system of the related-art position indicator including the pressure detecting unit described with FIG. 16. As described by using FIGS. 16 and 17, in the case of the related-art position indicator including the pressure detecting unit with the configuration including the variable-capacitance capacitor, when even a slight pressing force is applied to the core body, a pressure level according to the pressing force is detected. That is, in the case of the related-art position indicator, detection of the pressing force is carried out even when the pressing force applied to the core body of the position indicator is small (specifically, equal to or smaller than 100 gf) as shown by a graph J in FIG. 11.

On the other hand, suppose that the tablet information terminal 200 to which an operation input is made by using the position indicator 100 of the present embodiment does not stably recognize the position indicated by the position indicator 100 unless a pressing force of 100 gf as an example of the upper limit of the initial load is applied to the position indicator 100, for example. In this case, the position indicator 100 is so configured that the elastic member 3 biases the core body 2 toward the tip of the position indicator 100 with a pressure value of 100 gf (Pn=100 gf).

Due to this, in the case of the position indicator 100, the core body 2 does not apply a pressure to the pressure detecting unit 4 and thus detection of the pressing force is not carried out until the pressing force applied to the core body 2 on which the cap 1 is mounted reaches the pressure value of 100 gf. As above, in the case of the position indicator 100, an interval A shown in FIG. 11 (interval in which the position indicated by the position indicator 100 cannot be properly detected on the side of the tablet information terminal 200) can be set as a so-called dead zone in which the detection of the pressing force is not carried out.

In the case of the position indicator 100, as shown by a graph P in FIG. 11, when the pressing force applied to the core body 2 on which the cap 1 is mounted reaches the pressure value of 100 gf corresponding to the upper-limit value of the initial load, pressing of the pressure detecting unit 4 by the core body 2 is started according to the pressing force. Thus, detection of the pressing force in the pressure detecting unit 4 is carried out.

Due to this, the input range of the pressing force in the pressure detecting unit 4 after the detection of the position indicated by the position indicator 100 is enabled in the tablet information terminal 200 is a range of 100 gf to 600 gf resulting from shifting the original graph curve to the right as it is by 100 gf, which is the resilience of the elastic member 3. Thus, 500 gf can be kept as the effective input range R of the position indicator.

That is, with input loads equal to or higher than the input load with which detection of the indicated position becomes possible, associating with the pressing force can be carried out and the accuracy (resolution) can be kept, with the same effective input range R as the related art kept.

### Effects of First Embodiment

As above, the elastic member 3 between the core body 2 and the pressure detecting unit 4 applies a force (=Pn) corresponding to the initial load as an adjustment measure to the core body 2 by resilience given at the time of assembling due to the engagement between the core body 2 and the casing or the core body locking member 5. This adjustment allows the pen tip member to be selected depending on the position detecting device independently of the pressure detecting unit 4. Furthermore, the position indicator that enables writing pressure detection using the whole of the effective input range width of the pressure detecting unit 4 can be realized.

### Second Embodiment

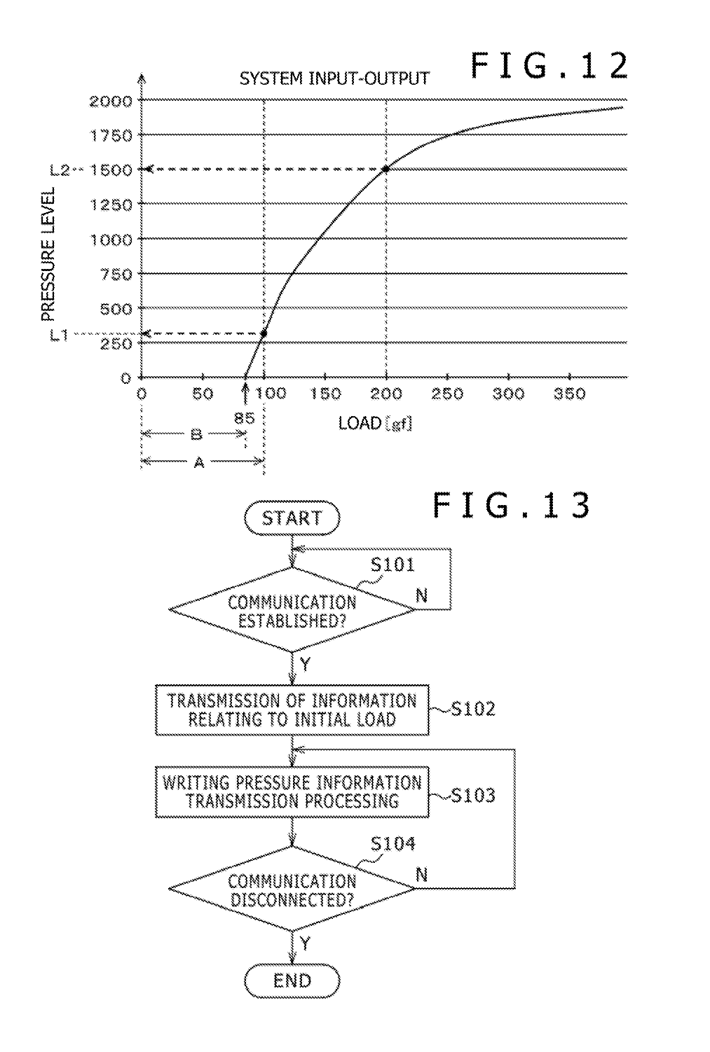

FIG. 12 is a diagram for explaining adjustment of the initial load in a second embodiment. A position indicator of the second embodiment has the same configuration as the position indicator 100 of the above-described first embodiment but has a characteristic in resilience given corresponding to the initial load.

The elastic member 3 between the core body 2 and the pressure detecting unit 4 described in the first embodiment is configured to apply a force (=Pn) corresponding to the initial load to the core body 2 when being compressed to the maximum extent. As the resilience of the elastic member 3 in this case, up to the upper-limit value of the initial load assumed according to the detection sensitivity of the indicated position in the tablet information terminal 200 can be permitted.

In contrast, in the position indicator 100 of the second embodiment, the pressure given to the core body 2 by the operation of the elastic member 3 is set to a pressure slightly lower than the initial load assumed according to the detection sensitivity of the indicated position in the tablet information terminal 200, specifically, e.g., 85 gf. This means that the maximum load in a dead-zone region shown in FIG. 12 (width B in the diagram) is set smaller than the upper-limit value of the initial load (maximum load in the region with a width A in the diagram).

### Effect of Second Embodiment

That the force for allowing the pressure detecting unit 4 to start detection of a writing pressure value (maximum load in the region with the width B in the diagram) is smaller than the force with which the tablet information terminal 200 starts to output the position of the position indicator 100 (maximum load in the region with the width A in the diagram) means that writing pressure data can be surely supplied to the tablet information terminal 200 when an indicated position can be detected in the tablet information terminal 200.

This can avoid a situation in which a point (X, Y, P) at which only 0 can be obtained as the writing pressure value (P) although an indicated position (X, Y) can be acquired is caused as the system.

### Third Embodiment

The case in which the resilience of the elastic member 3 of the position indicator 100 is lower than the upper-limit value of the initial load as described in the second embodiment will be amplified.

If the resilience of the elastic member 3 is lower than the upper-limit value of the initial load, there is a possibility that the resilience of the elastic member 3 is completely lost due to the aged deterioration of the elastic member 3. Furthermore, it is also possible that the pen tip member is changed depending on a product to be used.

Therefore, as a position indicator 100 of a third embodiment, a position indicator that enables use of the writing pressure value corresponding to the initial load is realized due to cooperation with the tablet information terminal 200.

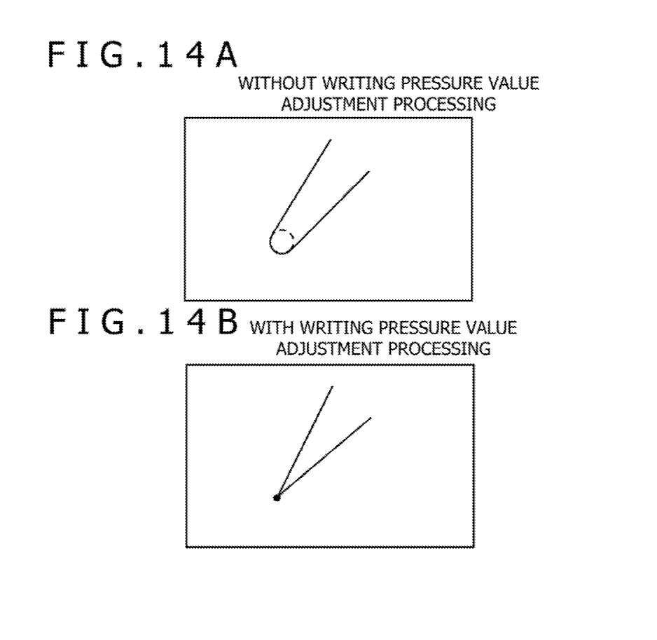

FIG. 13 is a flow diagram showing the operation of the position indicator 100 in the present embodiment. The following processing is implemented by the writing pressure signal transmitting unit 302 shown in FIG. 2.

First, in S101, the writing pressure signal transmitting unit 302 determines whether communication with the tablet information terminal 200 has been established. For example, the IC 302a may carry out this determination depending on whether or not that predetermined processing such as pairing has been executed has been notified from a communication unit of Bluetooth (registered trademark) or the like as the transmitting circuit 302b.

If communication has been established (determination of S101 results in YES), the IC 302a of the writing pressure signal transmitting unit 302 executes transmission processing of information relating to the initial load (S102).

The information relating to the initial load is information for providing a receiving device (position detecting device) with the relationship between the applied writing pressure and the corresponding output value in the position indicator 100 formed by combining a pen tip member and the pressure detecting unit 4 that are selected independently of each other.

In this information relating to the initial load, writing pressure data (RAW_C0) counted in the state in which a writing pressure is not generated in the core body 2 (approximate zero-load state) can be included, for example. A value immediately after the establishment of this communication link (immediately after the pen activation) may be used as the information relating to the initial load.

Furthermore, the following way may also be employed, for example. When the pen tip is replaced by an arbitrary pen tip, the IC 302a is made to acquire a count value in a state in which a load serving as a predetermined basis (e.g., load at the time of 400 gf) is applied, and the acquired count value is stored in the IC 302a. Then, in S102, the writing pressure data acquired from the information stored in this manner is used as the information relating to the initial load. Moreover, it is also possible to absorb variation in the accuracy among parts of the pen tip member by recording these pieces of information on each casing basis.

In the processing of FIG. 13, writing pressure data RAW_CL1 obtained when an assumed initial load (upper-limit value of the initial load, 100 gf in the example of FIG. 12) is applied to the position indicator 100 (writing pressure data when a load corresponding to a pressure level L1 on the ordinate (100 gf) is given) and writing pressure data RAW_CL2 obtained when a load of 200 gf is applied to the position indicator 100 (writing pressure data when a load corresponding to a pressure level L2 on the ordinate (200 gf) is given), shown in FIG. 12, are transmitted as the information relating to the initial load (S102). Next, the writing pressure signal transmitting unit 302 executes processing of detecting and transmitting the present writing pressure data (S103). The writing pressure signal transmitting unit 302 continues the processing of the step S103 until receiving a stop command such as communication disconnection or the like (S104, NO). The above is the operation on the side of the position indicator 100.

The control circuit 230 of the tablet information terminal 200 receives the information relating to the initial load, transmitted from the position indicator 100 identified by pairing or the like. Thereafter, on the basis of the received information relating to the initial load, the control circuit 230 sets the writing pressure data RAW_CL1 corresponding to L1 and the writing pressure data RAW_CL2 corresponding to L2. Then, according to a predetermined prediction function in which the partial range of these pieces of writing pressure data is set as a partial region of the effective input range R, the control circuit 230 derives a writing pressure correspondence function (or curve) corresponding to the effective input range R.

From then on, when receiving writing pressure data from the identified other side, the tablet information terminal 200 calculates (derives and decides) an adjustment value for being used for a predetermined application on the basis of the writing pressure correspondence function derived in the above-described manner and treats the adjustment value as information to be used for use of the application.

Due to this, when information on the position is obtained, application processing associated with writing pressure information can be necessarily executed and the value thereof can be properly used for the application.

FIGS. 14A and 14B show diagrams for explaining one example of an application using the adjustment of the writing pressure value in the tablet information terminal 200. In FIGS. 14A and 14B, a case in which the resilience of the elastic member 3 has weakened due to aged deterioration is shown. In this case, when the pressure level (writing pressure value) is calculated without using the writing pressure correspondence function derived based on information relating to the initial load, a heavy line is drawn from the first as shown in FIG. 14A. In contrast, when the pressure level (writing pressure value) is calculated by using the writing pressure correspondence function derived based on the information relating to the initial load, a line that is at a dot state at first and gradually becomes heavier from the dot state can be drawn as shown in FIG. 14B.

As above, according to the position indicator 100 in accordance with the present embodiment, it is possible to prevent the occurrence of time deviation between the timing when calculation of the pressure level according to writing pressure data from the position indicator 100 is started and the timing when detection of the position indicated by the position indicator 100 in the tablet information terminal 200 is started. Moreover, the pressure level according to the writing pressure data from the position indicator 100 can be properly grasped and display control processing in which the writing pressure is also taken into consideration in addition to the indicated position can be properly executed.

Specifically, first, forming the position indicator 100 with the configuration of the second embodiment eliminates a situation in which detection of the writing pressure value is later than detection of the position indicated by the position indicator 100 in the tablet information terminal 200. Thus, the need to assume the case in which the detection of the writing pressure is later than the detection of the indicated position and cope with this case is also eliminated.

Furthermore, forming the position indicator 100 with the configuration of the third embodiment can realize a position indicator that can offer, to the position detecting device side, processing of properly correcting the difference in the reaction load between the pressure detecting unit and the position detecting device on the basis of the combination of the pen tip member and the pressure detecting unit that can be selected independently of each other.

### MODIFICATION EXAMPLES

The following modifications are possible about the respective embodiments.

### (About Cap 1 and Core Body 2)

It is explained that the cap 1 can be attached and detached to and from the cap retaining part 2a of the core body 2. However, the core body and the cap may be formed as a monolithic member. If they are formed of separate members, plural caps different in electrical conduction properties, shape, and size can be prepared and be attached to the core body 2 to be used with replacing with each other. In this case, if the need to adjust the initial load (pressure value Pn) given to the core body 2 by the elastic member 3 arises, the joining position between the core body locking member 5 and the casing 101 joined to each other through screwing of threads to each other is adjusted as described above.

Furthermore, if plural different tablet information terminals are used, by replacing the cap with another cap different in electrical conduction properties, shape, and size depending on the tablet information terminal to be used or adjusting the joining position between the core body locking member 5 and the casing 101, the state of the position indicator 100 can be adjusted so that both detection of the indicated position and detection of the pressing force can be properly carried out.

Furthermore, the cap 1 can be formed by various materials having electrical conductivity and the size of the space made inside and so forth can also be set to various sizes. In the case of a material having high resilience (elastic force), the space does not need to be made inside. However, when the space is made inside the cap, the cap 1 that can be modified more easily can be formed.

Moreover, the flange part 2c does not have to be a one-stage flange and may have multiple-stage flanges. It suffices that two surfaces whose normals are along the axial center direction of the core body can be formed by a flange at any stage.

It is obvious that expressions of normal direction, parallel, vertical, and so forth include substantially normal direction, substantially parallel, and substantially vertical in the range of the design.

### (About Elastic Member 3)

The case in which the elastic member 3 is a coil spring is described as an example. However, the elastic member 3 is not limited thereto. Various elastic members having the same operation and effects as the coil spring 3, such as a plate spring, rubber, resin, a circular cylindrical elastic member formed into a bellows shape, can be used so that a force for counteracting a predetermined initial load can be given to the core body 2.

### (About Pressure Detecting Unit 4)

The pressure detecting unit 4 to detect the writing pressure is explained by using the writing pressure detecting unit described in Patent Document 2. However, it is also possible to use another pressure sensor other than it. For example, it is also possible to form the pressure detecting unit by a device called an MEMS described in Japanese Patent Application No. 2012-15254 and so forth.

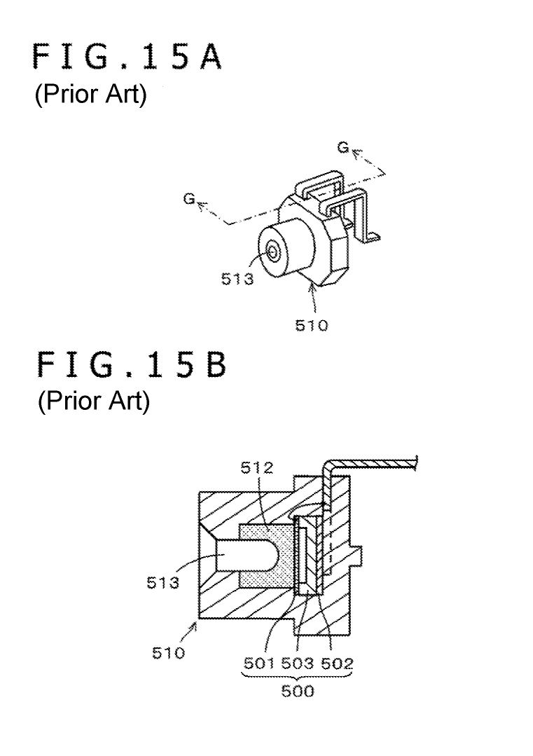

FIGS. 15A and 15B show diagrams for explaining one example of the pressure detecting unit using this MEMS. FIG. 15A shows the appearance. FIG. 15B is a sectional view when the pressure detecting unit is cut along line G-G in FIG. 15A. Hereinafter, the pressure detecting unit of this example will be referred to as a pressure sensing semiconductor device of the capacitive system (hereinafter, referred to as the pressure sensing device) in order to distinguish it from the pressure detecting unit 4 having the configuration with the above-described variable-capacitance capacitor.

The pressure sensing device is made by sealing, e.g., a pressure sensing chip 500 formed as a semiconductor device fabricated by a MEMS technique in, e.g., a package 510 of a cubic or rectangular parallelepiped box shape. The pressure sensing chip 500 is to detect an applied pressure as change in the capacitance.

A configuration is made in which the pressing part 2d of the core body 2 is inserted into a communicating hole 513 of the pressure sensing device and is elastically retained by an elastic member 512. This causes the capacitance of the pressure sensing chip 500 to have a value according to the pressure applied to the tip part of the core body, which enables detection of the writing pressure.

Alternatively, the pressure detecting unit may be a unit using a piezoelectric element.

The pressure detecting unit may be a unit that has a passive element using a piezoelectric effect to transform a force applied to a piezoelectric body to a voltage and can detect the pressure as a voltage level. Besides, a unit of an optical system and so forth are included in the range of the equivalence of the pressure detecting unit.

### (About Core Body Locking Member 5)

As described by using FIGS. 4 to 11, the core body locking member 5 serving as a unit that houses the core body 2, the elastic member 3, and the pressure detecting unit 4 inside the casing 101 and restricts the positions thereof is joined to the casing 101 through screwing of the thread made inside an end part of the casing 101 to the casing joining part 5c. Thus, the joining position can be adjusted by adjusting the state of the screwing of both.

Specifically, when the core body locking member 5 is screwed to the casing 101 until the position restricting part 5b of the core body locking member 5 abuts against the casing 101, the distance between the core body 2 and the pressure detecting unit 4 can be set to the shortest distance. In this case, the pressure value Pn of the elastic member 3 provided between the core body 2 and the pressure detecting unit 4 becomes the maximum value in the state in which the core body locking member 5 is joined to the casing 101. However, the pressure value Pn of the elastic member 3 provided between the core body 2 and the pressure detecting unit 4 can be set smaller by loosening the screwing state between the core body locking member 5 and the casing 101 to cause the position restricting part 5b of the core body locking member 5 to be located at a position separate from the casing 101.

A configuration in which the position restricting part 5b is not provided in the core body locking member 5 may be employed. Furthermore, the adjustment range of the pressure value Pn can be increased by extending the length of the casing joining part 5c in the axial center direction and ensuring a longer part as the part where the thread inside the end part of the casing 101 is made. Alternatively, the core body locking member 5 may be formed as a component monolithic with the casing 101.

### (About Retaining Member 6 and Holder 7)

In the above-described embodiment, it is explained that the pressure detecting unit 4 is fixed at a predetermined position on the retaining member 6 by using the holder 7. In this case, it will also be possible that a configuration in which part of the holder 7 intervenes between the core body 2 and the pressure detecting unit 4 is made. Even when a configuration in which the elastic member 3 is provided between the core body 2 and the holder 7 is made, the operation and functions of the elastic member 3 are not different from the case in which the elastic member 3 is provided between the core body 2 and the pressure detecting unit 4 because the holder 7 can be regarded as part of the pressure detecting unit 4.

Therefore, it is possible to employ a form in which the pressure detecting unit 4 is directly fixed to the retaining member 6 through, e.g., an increase in the thickness of the outside casing of the pressure detecting unit 4 and a form in which the pressure detecting unit 4 is directly fixed to the casing 101 through, e.g., a provision of a protrusion not on the retaining member 6 but in the casing 101. Furthermore, even when a configuration in which any component such as the holder 7 is provided between the core body 2 and the pressure detecting unit 4 is made, no problem is caused and it suffices that a state in which the elastic member 3 is interposed between opposed surfaces of the core body 2 and the pressure detecting unit 4 is obtained.

### (About Circuit Board 8 and Writing Pressure Signal Transmitting Unit 302)

As described in the second embodiment, the output of the writing pressure detecting mechanism unit 301 (amount that changes according to the writing pressure) may be fixed while the load applied to the pen tip is lower than the upper-limit value of the initial load. The degree of transmission of a force between the pressing part 2d and the pressure detecting unit 4 possibly differs depending on the linkage between them, which is possibly changed in the range of design matters from the gist of the present invention (including whether or not they abut against each other, whether or not a mediate member exists, whether a gap is present or absent, and so forth). It suffices that the writing pressure signal transmitting unit 302 is a unit that transmits or supplies a value obtained by unloading part of the initial load by the existence of the elastic member 3 as described above as a signal value (analog signal or digital value) decided according to the value.

The transmission or supply of the signal does not need to be carried out in real time. The signal may be transmitted after being retained in a memory for a predetermined time. Furthermore, the transmission or supply may be carried out after predetermined statistical processing is executed. The signal may be transmitted after processing such as some kind of smoothing processing, derivation of a median of a window interval, and statistical processing typified by histogram smoothing processing is executed in accordance with a protocol (format) with the device side such as a position detecting device.

The term of the “transmitting circuit” does not intend to exclude data reception of the transmitting circuit.

### (Casing 101 and Other Components)

The casing 101 does not have to be a component having a so-called pen shape. It is obvious that the tubular casing may have a shape other than the circular columnar shape. The “tubular” means that the casing exists to surround at least part of the circumference of the core body 2 from the outside. Furthermore, the tubular casing 101 defined here also encompasses a component that does not all appear a tubular shape for the purpose of mounting of a large-size battery or the like.

Furthermore, based on the premise that a publicly-known pressure detecting unit is incorporated, the above-described arbitrary parts or members may be formed as the same member as long as it is compatible with the gist of the present invention.

(Others and Modifications about System)

In the above-described respective embodiments, explanation is made with use of the tablet information terminal about the terminal used with the position indicator. However, the use of the position indicator is not limited to the so-called capacitive tablet terminal.

### (About Position Indicator 100)

Although it is explained that the position indicator indicates a position, the position indicator is not limited to a device for indicating a coordinate position like a pointing device such as a mouse for example. It suffices that the position indicator is a device that gives any input from a user to a tablet information terminal by using the spatial position of the pen tip for operation by the user and in order to distinguish a predetermined region displayed on a screen from the other region.

### (About Tablet Information Terminal (Position Detecting Device) 200)

Any device may be used as the position detecting device used with the position indicator as long as it is a device that can detect the position of the pen tip of the position indicator by forming capacitance with the pen tip (core body or cap) of the position indicator or through pressing by the pen tip of the position indicator and is a device that can receive a value corresponding to a writing pressure transmitted or supplied from the position indicators described in the respective embodiments by any method. Examples of the latter include a position detector equipped with a sensor of a pressure sensitive system. These examples will include mobile phones, various kinds of electronic stationery, large-screen displays, bank terminals, servers in so-called cloud services, and so forth each including the position detecting device.

Furthermore, the information relating to the initial load in the third embodiment may be not a count value thereof but identification information for identifying the profile of a curve for correction based on an ID.

### (About Communication Channel CH and Antenna)

It is explained that the communication channel CH can use various kinds of wireless communications using Bluetooth (registered trademark) or the like. However, the communication channel CH is not limited thereto. It suffices that the communication channel CH is a measure that allows the tablet information terminal to obtain, from the position indicator, information corresponding to a force generated from the input operation surface 200a to the core body in the vertical direction. For example, communication through the communication channel CH may be wired communication or may be wireless communication using infrared. Alternatively, communication through the communication channel CH may be communication using so-called near field communication (NFC) or may be communication based on a standard of wireless wide area network communication referred to as the so-called third or fourth generation communication.

Furthermore, if the position indicator is a device that can supply information to the tablet information terminal by using the pen tip as a transmission antenna, the electrode disposed in the sensor unit can be used as an antenna on the tablet information terminal side.

In this case, it will be possible to use the electrode of the sensor unit for detection of the indicated position and detection of the writing pressure in a time-sharing manner for example. Of course, it is also possible to additionally provide an antenna for receiving writing pressure data on the tablet information terminal side at arbitrary one or plural positions. It is also possible to carry out division multiplexing communication in which one or more of time, frequency, space, and code are multi-dimensionally combined.

It is also possible to make a configuration by combining the above-described respective embodiments without departing from the gist of the present invention.

The embodiments of the present invention can be used as a position indicator.

What is claimed is:

1. A position indicator comprising:
a core body including a tip part that protrudes from one opening of a casing in an axial center direction to outside of the casing and a rear end part located on a side of the core body opposite to the tip part;
a pressure detector that is housed in the casing in a state in which the pressure detector is pressable by the rear end part, wherein the pressure detector, in operation, detects a writing pressure applied to the tip part based on a pressure received from the rear end part;
a retaining member that retains the pressure detector at a predetermined position in the axial center direction in the casing; and
an elastic member that is provided between the pressure detector and the core body and that applies a pressure corresponding to an initial load in a direction from the rear end part toward the tip part to the core body.

2. The position indicator according to claim 1, wherein
the tip part is configured to be deformed according to the writing pressure,
the tip part of the position indicator is pressable against an operation surface of a position detector,
the position, detector in operation, starts detection of a contact position of the tip part on the operation surface if an amount of deformation of the tip part reaches a predetermined amount after the tip part makes contact with the operation surface, and
the pressure applied by the elastic member is equal to or lower than the initial load that is the writing pressure at which the amount of deformation of the tip part becomes the predetermined amount.

3. The position indicator according to claim 1, wherein
the pressure is applied by the elastic member to the core body by disposing the elastic member in a compressed state between the pressure detector and the core body.

4. The position indicator according to claim 2, wherein
the position detector is a position detector of a capacitive system, and
the tip part has electrical conductivity.

5. The position indicator according to claim 2, wherein
the initial load is a force equal to or larger than 5 gf.

6. The position indicator according to claim 4, wherein
the elastic member has electrical conductivity.

7. The position indicator according to claim 4, wherein
the elastic member is a metallic coil spring.

8. The position indicator according to claim 1, wherein
the core body includes a flange part having a shape that bulges from a main body part of the core body located between the tip part and the rear end part, and
the flange part includes two surfaces whose normal directions are each the axial center direction.

9. The position indicator according to claim 8, further comprising
a core body locking member that includes a casing joining part joined to the casing and a protrusion that engages with the flange part of the core body and restricts movement of the core body toward the tip part.

10. The position indicator according to claim 9, wherein
the casing joining part is configured to enable adjustment of a position of the core body locking member relative to the casing in the axial center direction, and
the pressure applied by the elastic member is adjustable by adjusting the position of the core body locking member relative to the casing by the casing joining part.

11. The position indicator according to claim 1, wherein
a gap is formed between the rear end part and the pressure detector in a state in which the writing pressure is not applied to the tip part.

12. The position indicator according to claim 11, wherein
length of the gap in the axial center direction is at least 1 μm and at most 300 μm.

13. The position indicator according to claim 2, wherein
an electrically-conductive cap is put disposed over the tip part of the core body, and
a pressure value of the initial load is a value according to a kind of the cap.

14. The position indicator according to claim 10, wherein
the cap is disposed over the tip part and forms a predetermined space between the cap and the tip part, and
the core body has a through-hole opened toward the predetermined space.

15. The position indicator according to claim 1, wherein
the pressure detector includes a plate-shaped dielectric having first and second planes opposed to each other, a first electrode disposed opposed to the first plane, and a second electrode disposed opposed to the second plane,
the second electrode is formed of an electrical conductor having elasticity, and
a capacitance of a capacitor formed by the first and second electrodes changes according to a contact area between the second electrode and the dielectric.

16. The position indicator according to claim 1, wherein
the pressure detector includes a semiconductor device having a capacitance that changes according to the writing pressure applied to the tip part.

17. The position indicator according to claim 2, wherein
a resilience of the elastic member in a state in which the writing pressure is not applied to the tip part is lower than a force of an upper-limit value of the initial load.

18. A position indicator used with a receiver including a controller capable of processing writing pressure data, the position indicator comprising:
a core body including a pen tip part;
a pressure detector which, in operation, detects a force transmitted from the core body; and
a writing pressure transmitting unit that is triggered to transmit information relating to an initial load by establishment of a communication link with the receiver, and then continuously transmits the writing pressure data indicating the force detected by the pressure detector until the communication link is disconnected.

19. The position indicator according to claim 18, wherein
the information relating to the initial load includes the writing pressure data measured in a state in which a predetermined pressure is applied to the pen tip part.

20. The position indicator according to claim 19, wherein
the information relating to the initial load includes the writing pressure data measured in a state in which a pressure is not applied to the pen tip part.
